(19) United States
(12) Patent Application Publication
(10) Pub. No.: US 2015/0115054 A1
(43) Pub. Date: Apr. 30, 2015

(54) FLOW RESTRICTOR

(71) Applicant: Watermiser, LLC, Encinitas, CA (US)

(72) Inventor: John Schommer, Frederic, WI (US)

(21) Appl. No.: 14/528,778

(22) Filed: Oct. 30, 2014

Related U.S. Application Data
(60) Provisional application No. 61/897,432, filed on Oct. 30, 2013.

(51) Int. Cl. B05B 1/34

(52) U.S. Cl. CPC B05B 1/34
USPC 239/1; 239/589

(57) ABSTRACT

The present invention sets forth a fluid flow restrictor for attachment onto a fluid dispensing fixture and related methods. The restrictor includes a restrictor body having an internal flow passageway. The restrictor also includes an upstream fluid receiving chamber having a tapered interior configuration that tapers from an upstream end of the upstream fluid receiving chamber towards a downstream end of the upstream fluid receiving chamber. The restrictor further includes a downstream fluid passing chamber immediately adjacent the downstream end of the upstream fluid receiving chamber. The upstream fluid receiving chamber and the downstream fluid passing chamber are configured so that fluid flow proceeds (i) through the upstream fluid receiving chamber, (ii) then through the downstream fluid passing chamber, and (iii) then directly into air. The downstream fluid passing chamber comprises a substantially cylindrical configuration.

### RELATED APPLICATION

This application claims priority to U.S. Provisional Patent Application No. 61/897,432, filed on Oct. 30, 2013 entitled “Flow Restrictor,” which is hereby incorporated by reference for all purposes.

### BACKGROUND

Water conservation plays an important role in today's society. Efficiently managing water resources helps to save usable water, reduce energy consumption, and decrease sewage costs. Efforts to conserve water resources have been varied. Residential, commercial, and industrial plumbing infrastructure, for example, incorporates technological advances aimed at decreasing water usage, utilizing efficient energy transfer, and re-use techniques. However, many technological designs fail to appreciate end-use concerns. Some end-use concerns involve consumers in commercial and residential environments, where designs for use with faucets and showers provide some improvements in water conservation, but usually at the expense of consumer expectations such as water pressure and desired flow rate.

Many devices are available for restricting water flow. One example of a device used with faucets is a water pressure modulating device having a spout-receiving portion that couples with a faucet spout. Another example of a device used with faucets is an elastic faucet guard attachment having a tubular inlet portion and a restricted outlet portion that terminates in an outlet slit that extends transversely of the outer end of the body of the device. Still another example of a device used with faucets is an adapter fitting having one end that fits over a faucet and another end that provides for a tube connection. Yet another example of a device used with faucets is a drainage hose formed of an elastic tube which includes a funnel shaped upper section that may be stretched over a water fixture, a cylindrical middle section, and a smaller cylindrical lower section.

One example of a flow restrictor device used with espresso machines is a steam supplying conduit having a partly conical nozzle with orifice. Such a device incorporates an extension with a funnel-shaped upper portion which receives the nozzle and a tubular lower portion with air supplying conduit that discharge to froth a supply of milk.

One example of a flow restrictor device used with garden hoses is a hand-operated, compressible bellowed conduit with upper and lower plate elements interconnected by folding side elements. Such a device allows a user to grasp the spout with the plate elements to apply a pinching action to influence the spray pattern of water exiting the spout.

There continues to be a demand for novel features and developments in flow-restricting, water conservation devices in the efforts to manage water resources in a socially, economically, and environmentally responsible manner, while still accommodating the desires of the end-user.

### BRIEF SUMMARY OF THE INVENTION

The present invention sets forth a fluid flow restrictor for attachment onto a fluid dispensing fixture and related methods. The restrictor includes a restrictor body having an internal flow passageway. The restrictor also includes an upstream fluid receiving chamber having a tapered interior configuration that tapers from an upstream end of the upstream fluid receiving chamber towards a downstream end of the upstream fluid receiving chamber. The restrictor further includes a downstream fluid passing chamber immediately adjacent the downstream end of the upstream fluid receiving chamber. The upstream fluid receiving chamber and the downstream fluid passing chamber are configured so that fluid flow proceeds (i) through the upstream fluid receiving chamber, (ii) then through the downstream fluid passing chamber, and (iii) then directly into air. The downstream fluid passing chamber comprises a substantially cylindrical configuration.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1a illustrates a see-through view of an embodiment of a flow restrictor of the present invention;

FIG. 1b illustrates a top view of the flow restrictor of FIG. 1a;

FIG. 1c illustrates a cross-sectional view of the flow restrictor of FIG. 1b taken along the line A-A of FIG. 1b;

FIG. 1d illustrates another top view of the flow restrictor of FIG. 1a;

FIG. 1e illustrates a cross-sectional view of the flow restrictor of FIG. 1d taken along the line B-B of FIG. 1d;

FIG. 1f illustrates a perspective, see-through view of the flow restrictor of FIG. 1a;

FIG. 2a illustrates a see-through view of another embodiment of a flow restrictor of the present invention;

FIG. 2b illustrates a top view of the flow restrictor of FIG. 2a;

FIG. 2c illustrates a cross-sectional view of the flow restrictor of FIG. 2b taken along the line C-C of FIG. 2b;

FIG. 2d illustrates a perspective, see-through view of the flow restrictor of FIG. 2a;

FIG. 3a illustrates a see-through view of an embodiment of a flow restrictor of the present invention;

FIG. 3b illustrates a top view of the flow restrictor of FIG. 3a;

FIG. 3c illustrates a cross-sectional view of the flow restrictor of FIG. 3b taken along the line A-A of FIG. 3b;

FIG. 3d illustrates another top view of the flow restrictor of FIG. 3a;

FIG. 3e illustrates a cross-sectional view of the flow restrictor of FIG. 3d taken along the line B-B of FIG. 3d; and

FIG. 3f illustrates a perspective, see-through view of the flow restrictor of FIG. 3a.

### DETAILED DESCRIPTION OF THE EMBODIMENTS

Devices described herein are capable of providing restricted flow with qualities such as rinsability (including desired pressure and flow rate), cleanliness, durability, low maintenance, and low cost. Such conservation devices manage water resources in a socially, economically, and environmentally responsible manner, while still accommodating other important factors in the design and manufacture of devices, including the desires of the end-user.

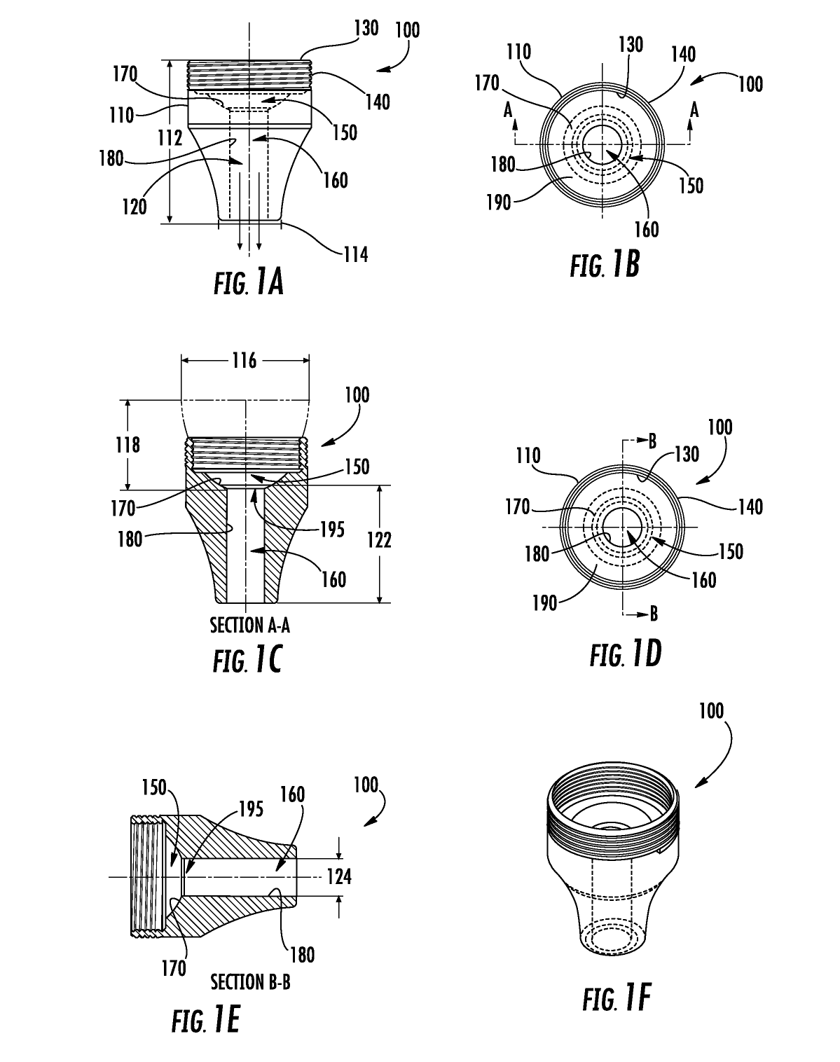

FIG. 1a illustrates a see-through view of an embodiment of a flow restrictor 100 of the present invention. Flow restrictor 100 includes a restrictor body 110, which can be made of metal, metal alloy, ceramic, composite, polymer, plastic, or any material suitable for accepting various types of fluids, based on the different properties of the fluids. Example materials for restrictor body 110 include copper, copper alloy, no-lead brass, chrome, stainless steel, iron, aluminum, polyvinyl chloride (PVC), and injection-molded plastic. Restrictor body 110 can also be made of a combination of materials, including a combination of materials such as those listed herein. In addition, restrictor body 110 may be rigid or flexible. A suitable material, such as copper, copper alloy, or approved composite, may be selected based on its approved use with potable water. Copper is suitable for certain applications because copper has been shown to be effective at inhibiting the growth of common infectious disease sources such as molds, fungi, algae, microbes, and other sources, which can be commonly found in warm, moist environments.

Restrictor body 110 includes an internal passageway 120 for fluid flow within flow restrictor 100. Any fluid may be used with the present invention, with reference made to water throughout for illustrative purposes. Restrictor body 110 may be any suitable length 112, including for example, 1.25 inches in length. All references provided herein to specific example values are approximate values within ±30 percent. Restrictor body 110 may include either or both an internal upstream coupling 130 and an external upstream coupling 140 for coupling restrictor body 110 into a water line. As an example, internal upstream coupling 130 may be used to attach flow restrictor 100 to the outer edges of a faucet spout. As an additional example, external upstream coupling 140 may be used to attach flow restrictor 100 to the inner edges of a faucet spout. As another additional example, external upstream coupling 140 may be used to attach flow restrictor 100 to a faucet spout via an external attachment which secures over the outside of a faucet spout and the outside of flow restrictor 100 at external upstream coupling 140. External attachment may be in the form of a pipe fitting or any other attachment suitable for coupling a faucet head to external upstream coupling 140 of flow restrictor 100. Flow restrictor 100 may be attached such that it may be removed or it may be attached such that it is fixed and cannot be removed. Internal upstream coupling 130 and external upstream coupling 140 may include threads, as shown by way of example in FIG. 1a, for coupling restrictor body 110 into a water line. Internal upstream coupling 130 and external upstream coupling 140 may also be any other design suitable for coupling.

Restrictor body 110 further includes an upstream water receiving chamber 150 and a downstream water passing chamber 160. Flow restrictor 100 may be attached to a water line in a unilateral direction such that upstream water receiving chamber 150 receives water flow from the water line and downstream water passing chamber 160 allows the water flow to exit the device in a maintained stream. The downstream water passing chamber 160 may be configured without any attachments, in order to facilitate the water exiting directly into air. Flow restrictor 100 may be inserted into a water line in various configurations, including vertically and horizontally. Upstream water receiving chamber 150 allows water entering upstream water receiving chamber 150 to proceed directly into the immediately adjacent downstream water passing chamber 160. In one embodiment, upstream water receiving chamber 150 and downstream water passing chamber 160 may comprise a single, integrated piece. In another embodiment, upstream water receiving chamber 150 and downstream water passing chamber 160 may use a design that allows upstream water receiving chamber 150 and downstream water passing chamber 160 to removably attach, couple, or connect together, such as by threads or other suitable design for attachment.

Upstream water receiving chamber 150 uses a tapered interior configuration which tapers from the upstream end or portion of upstream water receiving chamber 150 towards the downstream end or portion of upstream water receiving chamber 150. In an embodiment of the present invention, upstream water receiving chamber 150 incorporates an elliptical configuration, which tapers in an elliptical shape as upstream water receiving chamber 150 approaches downstream water passing chamber 160. This elliptically tapered interior configuration 170 provides several significant results. For example, particulate matter, including aggregated mineral-based particulates, such as freed calcium deposits, can create problems such as clogging and build-up in restricted-aperture, fluid-flow devices. Flow restrictor 100 of the present invention is particularly advantageous because, unlike other designs which may include corners and other areas that may accumulate water or debris build-up and/or promote contamination, flow restrictor 100 includes a design in which build-up and/or contamination are significantly minimized or eliminated. Moreover, flow restrictor 100 can fully self-drain without user input, such as cleaning or clearing of the device by a user using, for example, an external device.

The elliptically tapered interior configuration 170 of upstream water receiving chamber 150 can also create and accommodate substantially turbulent fluid flow in upstream water receiving chamber 150, which assists with dissolving particulate matter through a washing mechanism, while simultaneously assisting with the prevention of particulate matter becoming lodged in flow restrictor 100. Moreover, the design of upstream water receiving chamber 150 provides for a larger volume of water to be subject to turbulent flow than other designs, based on the design characteristics, such as the elliptical design and ellipse profiles. The volume of water can be further increased by using an elongated elliptical design or ellipse profiles of varying dimensions. The turbulent flow in upstream water receiving chamber 150 exits downstream water passing chamber 160 in substantially non-turbulent flow. Turbulent water flow can therefore be minimized through internal passageway 120 and the water flow exiting flow restrictor 100 can be substantially non-turbulent. These aforementioned attributes of the elliptical design of upstream water receiving chamber 150 assist with providing a self-cleaning, non-clogging device. It is also within the scope of the present invention that the elliptically tapered interior configuration 170 may alternatively be an angularly tapered interior configuration (discussed further herein), a circularly tapered interior configuration, or any other similar design, which may provide benefits similar to the elliptical design.

Downstream water passing chamber 160 uses a cylindrical configuration, which maintains a desired columnizing effect on a water stream as water from upstream water receiving chamber 150 enters and exits downstream water passing chamber 160. This cylindrical columnizer configuration 180 provides several significant results. For example, water exiting downstream water passing chamber 160 may exit flow restrictor 100 directly into the air as a substantially cylindrical column with parallel walls. The exit column of water is able to have a maintained shape and reliable stream, which may be especially desired by an end-user. Such a dedicated water stream also provides advantages over other devices that incorporate a design in which the water stream fluctuates or behaves erratically, or includes another water or air stream.

Downstream water passing chamber 160 may be shortened or lengthened to provide optimal water columnization at any given water pressure (generally described using the terminology pounds per square inch or PSI) and/or gallons-per-minute (GPM) flow rate. In addition, the diameter or cross-section of downstream water passing chamber 160 may also be selected based on the water pressure through the water line to achieve a desired flow rate. The selection of the dimensions of downstream water passing chamber 160 based on water pressure and desired flow rate helps to maintain a specific water pressure, while restricting or minimizing flow rate. The reduced flow rate at or near a point of use allows for properly maintained water pressure and distribution upon exiting of a flow of water into the air, while reducing water consumption. This provides significant advantages over a water pressure regulation system in which water pressure is decreased to reduce water consumption.

In an embodiment, cylindrical columnizer configuration 180 of downstream water passing chamber 160 may be in the form of a circular cylinder, elliptical cylinder, or substantially these or other various geometric shapes that are readily contemplated to be within the scope of the present invention. Furthermore, the portion of downstream water passing chamber 160 which exits flow restrictor 100 into the air may include a conical or internal or external, chamfered outermost tip portion 114, which may comprise a region of any length, including for example, 0.031 inches in length. Outermost tip portion 114 may flare outwardly from the internal portion of downstream water passing chamber 160 towards the outermost portion of restrictor body 110 as downstream water passing chamber 160 exits flow restrictor 100 into the air.

Another advantage of the design of the present invention is that flow restrictor 100 regulates water flow to achieve a desired gallons-per-minute flow rate through the device without requiring the use of additional devices such as aerators. The elimination of the need for additional devices to control flow, such as aerators, provides added utility to flow restrictor 100. For example, aerators can be a source of non-sterility in facilities such as hospitals, nursing homes, health clinics, health clubs, military bases, and educational facilities. By eliminating the need for additional devices such as aerators, water dispensing fixtures can eliminate a potentially dangerous source of contamination. However, simply removing aerators from water fixtures can ruin rinsability and eliminate any water conservation benefits. The advantages of the present invention allow for removal of additional devices such as aerators, without ruining rinsability and while still providing anti-microbial benefits and aiding water conservation efforts. Furthermore, there are reduced costs from the elimination of additional devices such as aerators because this also eliminates the need to clean and/or sterilize the aerators through procedures such as autoclaving. In addition, facilities may have regulations that ban devices such as aerators for sterility purposes. Finally, the elimination of aerators and other devices is a cost savings in any application.

FIG. 1b illustrates a top view of the flow restrictor of FIG. 1a. FIG. 1b includes references to previously described features of flow restrictor 100. In addition, FIG. 1b shows sealing wall 190 of restrictor body 110. Sealing wall 190 may be designed to accept a faucet fixture, such that restrictor body 110 may be removably or fixedly attached to a faucet. Sealing wall 190 may be manufactured as an integral part of restrictor body 110 or may comprise one or more sealing devices, which may be removable, such as O-rings, washers, gaskets, or other types of seals. These sealing devices may be made of any material suitable for the properties of the fluid in the fluid line.

The internal wall of sealing wall 190 directly approaches and is located immediately adjacent to the uppermost portion of upstream water receiving chamber 150, such that water proceeding past sealing wall 190 into upstream water receiving chamber 150 does not encounter any edges, corners, gaps, or other obstacles that would affect a stream of water flowing through the device or provide areas for possible contamination or other uncleanliness.

Sealing wall 190 may extend to the longitudinal edge of restrictor body 110 or may not extend to the longitudinal edge of restrictor body 110. As an example, sealing wall 190 may extend to the outermost vertical edge of restrictor body 110, in which case external upstream coupling 140 may be used to attach flow restrictor 100 to a faucet spout via an external attachment which secures over the outside of a faucet spout and the outside of flow restrictor 100 at external upstream coupling 140. By way of example, sealing wall 190 may be three O-rings vertically stacked to accept and provide a water-tight seal with the faucet spout at or near the longitudinal edge of restrictor body 110 and sealingly engage the water line, such that water flow from a water line proceeds directly from the faucet spout past sealing wall 190 and towards upstream water receiving chamber 150 in a straight column, without encountering any edges, corners, gaps, or other obstacles that would affect the stream of water or provide areas for possible contamination or other uncleanliness. The term “water-tight” refers to the ability to achieve a seal in which water does not enter or accumulate in regions of the device that are outside the defined path of water flow that is achieved via the device.

As another example, sealing wall 190 may not extend to the longitudinal edge of restrictor body 110, in which case internal upstream coupling 130 may allow for acceptance of a faucet spout, such that the faucet spout engages with sealing wall 190 within restrictor body 110, thereby providing a water-tight seal between the faucet spout and sealing wall 190 within flow restrictor 100, such that water flow from a water line proceeds directly from the faucet spout past sealing wall 190 and towards upstream water receiving chamber 150 in a straight column, without encountering any edges, corners, gaps, or other obstacles that would affect the stream of water or provide areas for possible contamination or other uncleanliness.

FIG. 1c illustrates a cross-sectional view of the flow restrictor of FIG. 1b taken along the line A-A of FIG. 1b. FIG. 1c includes references to previously described features of flow restrictor 100. FIG. 1c also shows an example elliptical profile of upstream water receiving chamber 150, wherein the minor axis 116 is 0.972 inches and the half-major axis 118 is 0.688 inches. Further example elliptical profiles of upstream water receiving chamber 150 are generally and specifically described in U.S. Patent Application Publication No. 2013/0037153 by Schommer entitled “Elliptical Chambered Flow Restrictor,” filed Aug. 8, 2012 and published Feb. 14, 2013, which is owned by the assignee of the present application and hereby incorporated by reference herein in its entirety for any and all purposes.

As further shown in FIG. 1c, restrictor body 110 can optionally use a chamfered interior design 195 as part of upstream water receiving chamber 150 and/or downstream water passing chamber 160, such that water flow entering upstream water receiving chamber 150 proceeds into downstream water passing chamber 160 over a chamfered interior design 195. The downstream water passing chamber 160 may be any length 122, including for example, 0.89 inches. The chamfered interior design 195 can be chamfered at any angle and length. For example, the chamfered interior design 195 can be chamfered at an angle of forty-five (45) degrees and a length of 0.01 inches. The chamfered interior design 195 may help to reduce noise from the flow of water through the water line by allowing the flow of water to enter the downstream water passing chamber 160 without encountering sharp edges, which may account for a squealing sound.

FIG. 1d illustrates another top view of the flow restrictor of FIG. 1a. FIG. 1d includes references to previously described features of flow restrictor 100.

FIG. 1e illustrates a cross-sectional view of the flow restrictor of FIG. 1d taken along the line B-B of FIG. 1d. FIG. 1e includes references to previously described features of flow restrictor 100. Downstream water passing chamber 160 may have a selectable cylindrical diameter 124 of any size, including one in the range from one-sixteenth of an inch to three-eighths of an inch, such as 0.281 inches. The dimensions chosen to restrict the flow of water through flow restrictor 100 may be selected based on the water pressure (generally described using the terminology pounds per square inch or PSI) in the water line and/or the flow rate (generally described using the terminology gallons-per-minute or GPM). The dimensions chosen may help to maintain a specific water pressure, while restricting or minimizing flow rate. For example, a restrictor design with appropriate dimensions may be selected to achieve a desired flow rate based on a specific water pressure.

FIG. 1f illustrates a perspective, see-through view of the flow restrictor of FIG. 1a. FIG. 1f includes reference to previously described features of flow restrictor 100. FIG. 1f depicts one example embodiment of the flow restrictor 100 of FIG. 1a. The outer shape and dimensions of flow restrictor 100 may vary according to functional and aesthetic concerns of the end-user. FIG. 1f provides one example of an outer design of flow restrictor 100 that is appropriate for flush engagement with a water dispensing fixture such as a faucet head, where aesthetic water conservation devices are desirable.

In summary, the design of flow restrictor 100, including upstream water receiving chamber 150 and downstream water passing chamber 160, enables fluid flow which decreases water pass-through, while helping to maintain the water pressure and desired gallons-per-minute flow rate for accommodating the desires of an end-user.

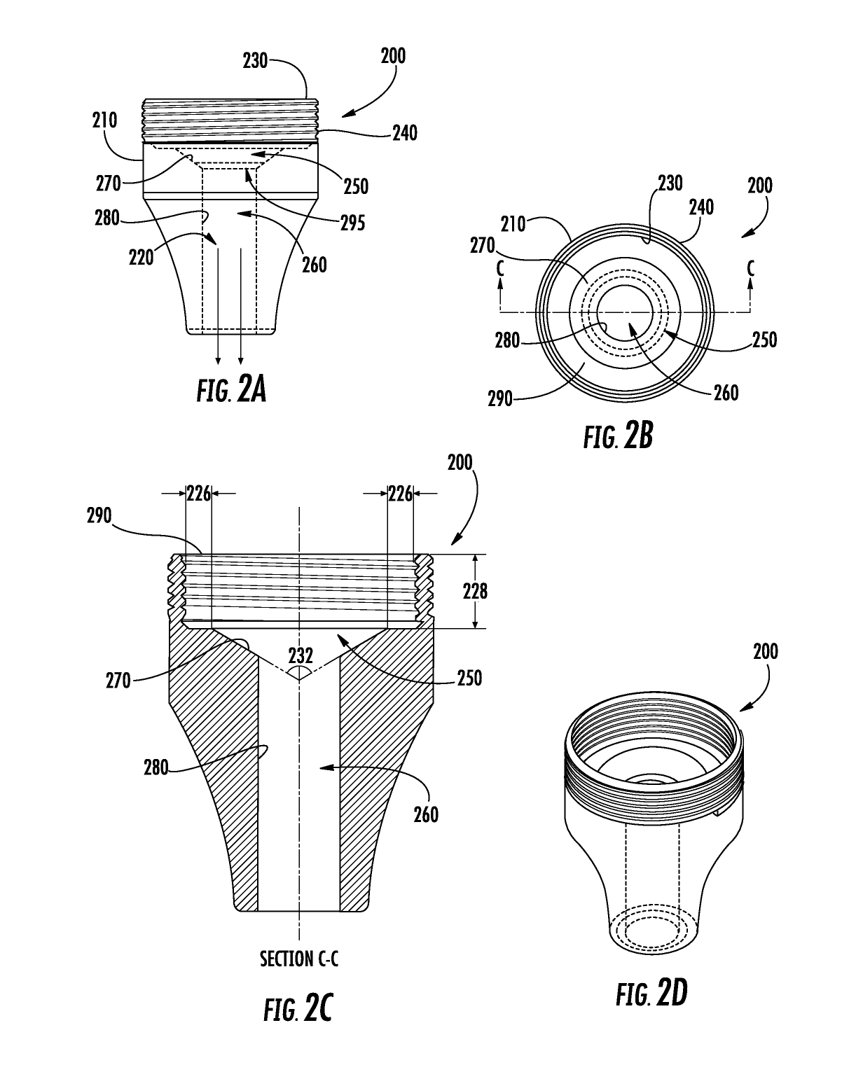

FIGS. 2a-2d depict another embodiment of a flow restrictor 200 according to the present invention. Except as described otherwise herein, the design and functionality of flow restrictor 200 shown in FIGS. 2a-2d is similar to that of flow restrictor 100 shown in FIGS. 1a-1f and described in connection with FIGS. 1a-1f. Accordingly, the figures use corresponding reference numbers.

FIG. 2a illustrates a see-through view of an example embodiment of a flow restrictor 200 of the present invention. In this embodiment, flow restrictor 200 includes an upstream water receiving chamber 250 with a tapered interior configuration which tapers from the upstream end or portion of upstream water receiving chamber 250 towards the downstream end or portion of upstream water receiving chamber 250. However, upstream water receiving chamber 250 in this embodiment incorporates an angled configuration, which tapers at an angle as upstream water receiving chamber 250 approaches downstream water passing chamber 260. This angularly tapered interior configuration 270 tapers at a fixed angle relative to downstream water passing chamber 260. Downstream water passing chamber 260 may be shortened or lengthened to provide optimal water columnization at a specific water pressure and/or flow rate.

FIG. 2a also shows optional chamfered interior design 295, which allows water flow entering upstream water receiving chamber 250 to proceed into downstream water passing chamber 260 over chamfered interior design 295. The chamfered interior design 295 may be manufactured as part of upstream water receiving chamber 250 and/or downstream water passing chamber 260 and may be chamfered at any angle and length. For example, the chamfered interior design 295 may be chamfered at an angle of forty-five (45) degrees and a length of 0.01 inches. The chamfered interior design 295 may help to reduce noise from the flow of water through the water line by allowing the flow of water to enter downstream water passing chamber 260 without encountering sharp edges, which may account for a squealing sound.

FIG. 2b illustrates a top view of the flow restrictor of FIG. 2a. FIG. 2b includes references to previously described features of the present invention.

FIG. 2c illustrates a cross-sectional view of the flow restrictor of FIG. 2b taken along the line C-C of FIG. 2b. FIG. 2c includes references to previously described features of the present invention. FIG. 2c also provides reference to sealing wall 290, which may be any desired width 226 and length 228, including for example 0.1125 inches in width and 0.25 inches in length. FIG. 2c further provides reference to angularly tapered interior configuration 270, which tapers at a fixed angle relative to downstream water passing chamber 260. Tapering angle 232 may be any desired angle, including for example 118 degrees.

FIG. 2d illustrates a perspective, see-through view of the flow restrictor of FIG. 2a. FIG. 2d includes reference to previously described features of the present invention.

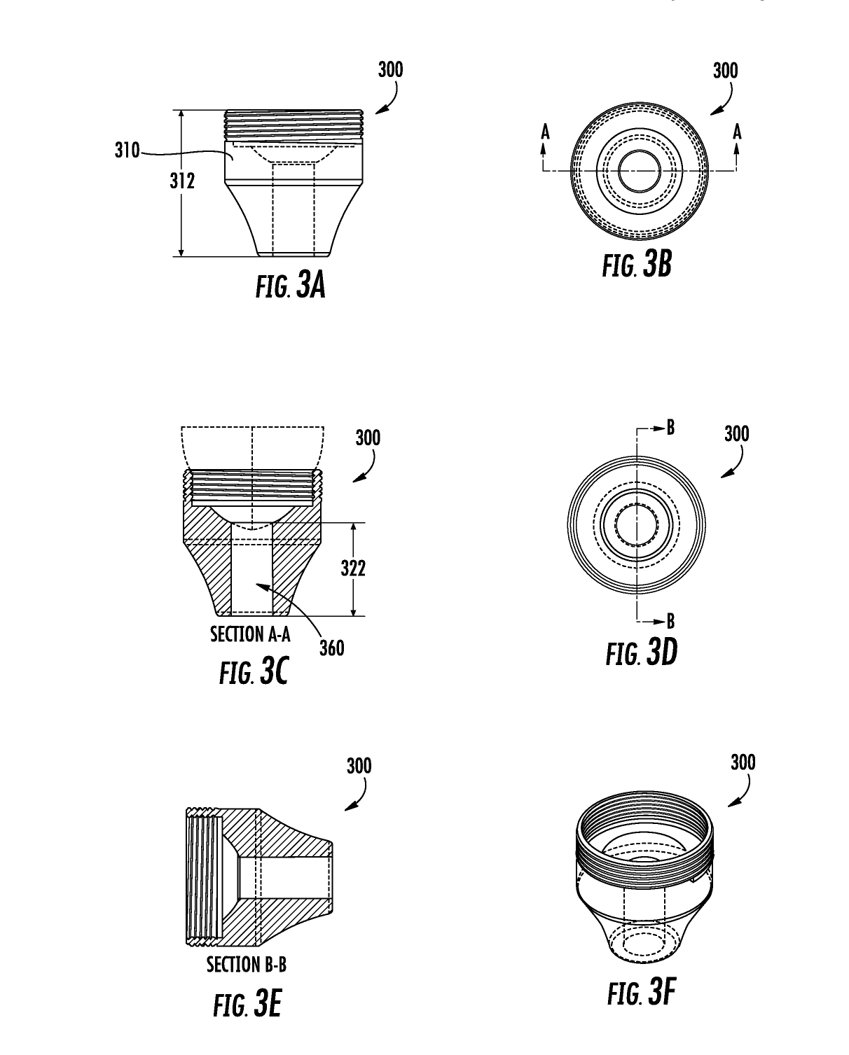

FIGS. 3a-3f depict another embodiment of a flow restrictor according to the present invention with alternative dimensions. The design and functionality of flow restrictor 300 shown in FIGS. 3a-3f is similar to that of flow restrictor 100 shown in FIGS. 1a-1f and described in connection with FIGS. 1a-1f. Accordingly, the figures use corresponding reference numbers.

FIG. 3a illustrates a see-through view of an example embodiment of a flow restrictor of the present invention. FIG. 3a includes references to previously described features of the present invention. FIG. 3a also provides reference to an alternative dimension for restrictor body 310. Restrictor body 310 may be any suitable length 312, including for example, 1.00 inches in length.

FIG. 3b illustrates a top view of the flow restrictor of FIG. 3a. FIG. 3b includes reference to previously described features of the present invention.

FIG. 3c illustrates a cross-sectional view of the flow restrictor of FIG. 3b taken along the line A-A of FIG. 3b. FIG. 3c includes references to previously described features of the present invention. FIG. 3c also provides reference to an alternative dimension for downstream water passing chamber 360. Downstream water passing chamber 360 may be any suitable length 322, including for example, 0.64 inches in length.

FIG. 3d illustrates another top view of the flow restrictor of FIG. 3a. FIG. 3d includes reference to previously described features of the present invention.

FIG. 3e illustrates a cross-sectional view of the flow restrictor of FIG. 3d taken along the line B-B of FIG. 3d. FIG. 3e includes reference to previously described features of the present invention.

FIG. 3f illustrates a perspective, see-through view of the flow restrictor of FIG. 3a. FIG. 3f includes reference to previously described features of the present invention.

Also provided within the scope of the present invention is a method of providing fluid flow restriction from a fluid dispensing fixture. Example embodiments are provided herein, wherein the terminology and application is provided as discussed in connection with the flow restrictor and its various example embodiments.

An example embodiment of the method comprises attaching a restrictor body to a dispensing end of a fluid dispensing fixture, wherein the restrictor body has an internal flow passageway including: (i) an upstream fluid receiving chamber having a tapered interior configuration that tapers from an upstream end of the upstream fluid receiving chamber towards a downstream end of the upstream fluid receiving chamber, and (ii) a downstream fluid passing chamber immediately adjacent the downstream end of the upstream fluid receiving chamber. The upstream fluid receiving chamber and the downstream fluid passing chamber are configured so that fluid flow proceeds (i) through the upstream fluid receiving chamber, (ii) then through the downstream fluid passing chamber, and (iii) then directly into air. The downstream fluid passing chamber comprises a substantially cylindrical configuration.

In an example embodiment of the present invention, the upstream fluid receiving chamber comprises an elliptically tapered interior configuration approaching the downstream fluid passing chamber. In another example embodiment, the upstream fluid receiving chamber comprises an angularly tapered interior configuration approaching the downstream fluid passing chamber. In another example embodiment, the upstream fluid receiving chamber comprises a circularly tapered interior configuration approaching the downstream fluid passing chamber. In another example embodiment, the restrictor body further includes an internal chamfered interior portion between the upstream fluid receiving chamber and the downstream fluid passing chamber. In another example embodiment, an outermost tip portion of the downstream fluid passing chamber is internally chamfered.

While the specification has been described in detail with respect to specific example embodiments of the present invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

The invention claimed is:

1. A fluid flow restrictor for attachment onto a fluid dispensing fixture, said fluid flow restrictor comprising:
a restrictor body having an internal flow passageway including:
an upstream fluid receiving chamber having a tapered interior configuration that tapers from an upstream end of the upstream fluid receiving chamber towards a downstream end of the upstream fluid receiving chamber; and
a downstream fluid passing chamber immediately adjacent the downstream end of the upstream fluid receiving chamber;
wherein the upstream fluid receiving chamber and the downstream fluid passing chamber are configured so that fluid flow proceeds (i) through the upstream fluid receiving chamber, (ii) then through the downstream fluid passing chamber, and (iii) then directly into air; and
wherein the downstream fluid passing chamber comprises a substantially cylindrical configuration.

2. The fluid flow restrictor according to claim 1, wherein the upstream fluid receiving chamber comprises an elliptically tapered interior configuration approaching the downstream fluid passing chamber.

3. The fluid flow restrictor according to claim 1, wherein a design of the downstream fluid passing chamber provides a columnizing effect on a fluid stream exiting the downstream fluid passing chamber.

4. The fluid flow restrictor according to claim 3, wherein the fluid stream exiting the downstream fluid passing chamber exits as a substantially cylindrical column with parallel walls.

5. The fluid flow restrictor according to claim 1, wherein the restrictor body further includes a sealing wall located immediately adjacent to an uppermost portion of the upstream fluid receiving chamber to accept and provide a fluid-tight seal with a fluid dispensing fixture.

6. The fluid flow restrictor according to claim 5, wherein an uppermost portion of the sealing wall is located at or near a longitudinal edge of the restrictor body.

7. The fluid flow restrictor according to claim 5, wherein an uppermost portion of the sealing wall is located within the restrictor body.

8. The fluid flow restrictor according to claim 1, wherein the restrictor body further includes an internal chamfered interior portion between the upstream fluid receiving chamber and the downstream fluid passing chamber.

9. The fluid flow restrictor according to claim 1, wherein an outermost tip portion of the downstream fluid passing chamber is internally chamfered.

10. The fluid flow restrictor according to claim 1, wherein an outermost tip portion of the downstream fluid passing chamber flares outwardly from an internal portion of the downstream fluid passing chamber towards the outermost portion of the restrictor body as the downstream fluid passing chamber exits the fluid flow restrictor.

11. The fluid flow restrictor according to claim 1, wherein an outermost tip portion of the downstream fluid passing chamber comprises a conical exit portion.

12. The fluid flow restrictor according to claim 1, wherein the downstream fluid passing chamber is configured without any attachments to facilitate the fluid exiting directly into air.

13. The fluid flow restrictor according to claim 1, wherein the upstream fluid receiving chamber comprises an angularly tapered interior configuration approaching the downstream fluid passing chamber.

14. The fluid flow restrictor according to claim 1, wherein the upstream fluid receiving chamber comprises a circularly tapered interior configuration approaching the downstream fluid passing chamber.

15. A method of providing fluid flow restriction from a fluid dispensing fixture, the method comprising:
attaching a restrictor body to a dispensing end of the fluid dispensing fixture, the restrictor body having an internal flow passageway including: (i) an upstream fluid receiving chamber having a tapered interior configuration that tapers from an upstream end of the upstream fluid receiving chamber towards a downstream end of the upstream fluid receiving chamber, and (ii) a downstream fluid passing chamber immediately adjacent the downstream end of the upstream fluid receiving chamber;
wherein the upstream fluid receiving chamber and the downstream fluid passing chamber are configured so that fluid flow proceeds (i) through the upstream fluid receiving chamber, (ii) then through the downstream fluid passing chamber, and (iii) then directly into air; and
wherein the downstream fluid passing chamber comprises a substantially cylindrical configuration.

16. The method of claim 15, wherein the upstream fluid receiving chamber comprises an elliptically tapered interior configuration approaching the downstream fluid passing chamber.

17. The method of claim 15, wherein the upstream fluid receiving chamber comprises an angularly tapered interior configuration approaching the downstream fluid passing chamber.

18. The method of claim 15, wherein the upstream fluid receiving chamber comprises a circularly tapered interior configuration approaching the downstream fluid passing chamber.

19. The method of claim 15, wherein the restrictor body further includes an internal chamfered interior portion between the upstream fluid receiving chamber and the downstream fluid passing chamber.

20. The method of claim 15, wherein an outermost tip portion of the downstream fluid passing chamber is internally chamfered.
